(19) United States
(12) Patent Application Publication
(10) Pub. No.: US 2003/0006899 A1
(43) Pub. Date: Jan. 9, 2003

(54) Method and system for acoustic detection of aerosol dissemination

(76) Inventors: Amir-Homayoon Najmi, Columbia, MD (US); Dexter G. Smith, Columbia, MD (US); Michael P. McLoughlin, Sykesville, MD (US); Harvey W. Ko, Ellicott City, MD (US)

Correspondence Address: Francis A Cooch, The Johns Hopkins University, Applied Physics Laboratory, 11100 Johns Hopkins Road, Laurel, MD, 20723-6099, US

(21) Appl. No.: 10/031,042

(22) PCT Filed: Jun. 22, 2001
(86) PCT No.: PCT/US01/19925

(51) Int. Cl. G08B 21/00

(52) U.S. Cl. 340/540; 367/13; 367/199

(57) ABSTRACT

Disclosed is a method for detecting unwanted dissemination of acrosolized agents into an HVAC system in a building by detecting the sound of the dissemination at the time it occurs. To be able to distinguish the sound of the dissemination event from the ambient background noise of the HVAC system, sound extraction techniques, e.g., high pass filtering and an adaptive variance estimator, are utilized which can detect the event's noise from within the ambient background noise of the system. A microphone continually monitors background sound levels and senses the additional sound resulting from the activation of the aerosol delivery system, which has a unique sound “signature”. Once an event is detected, defensive actions, e.g., activating additional sensors, closing all air vents, and shutting off the HVAC system, can be taken.

### CROSS REFERENCE TO RELATED APPLICATIONS

This application claims the benefit of prior filed co-pending U.S. Provisional Application No. 60/213,644, filed on Jun. 23, 2000.

### BACKGROUND OF THE INVENTION

1. Field of the Invention

This invention relates generally to a method and system for detecting a potential terrorist attack and, more particularly, to a method for detecting unwanted dissemination of aerosolized agents into an HVAC system of a building or into other environs inhabited by humans.

2. Description of the Related Art

Since at least the 1970's, terrorism has been a well known and recognized problem throughout the world. While guns and conventional explosives continue to be the weapons of choice for most terrorists, concerns are turning to the use of chemical, biological, radiological, or nuclear (CBRN) materials to achieve their goals. In 1995, a chemical agent, Sarin nerve gas, was released in the Tokyo subway by the Aun Shinrikyo group; the same group attempted to launch an anthrax attack in Tokyo later in 1995.

According to the report of the National Commission on Terrorism, issued on Jun. 5, 2000, “[i]t is difficult to predict the likelihood of a CBRN attack, but most experts agree that today's terrorists are seeking the ability to use such agents in order to cause mass casualties.” Countering the Changing Threat of International Terrorism: Report of the National Commission on Terrorism, pursuant to Public Law 277, 105^{th} Congress, Jun. 5, 2000.

One of the concerns about a CBRN attack is that it is extremely difficult to discover until a considerable amount of time has elapsed since its occurrence; frequently the symptoms experienced by the victims appear to be symptoms of common illnesses unrelated to a deliberate terrorist action. Indeed, the occurrence of the attack may not be discovered until a statistically inconsistent number of people are injured or killed in a concentrated area, thereby raising suspicions that the source of their problems is not simply an everyday illness.

A CBRN agent can be released into the air in a theater or an office building ventilation system discreetly, without an explosion or other warning sign evident to those under attack. One known method of releasing a CBRN agent is to utilize an aerosolizer such as those manufactured for the spraying of paint. The aerosolizer is placed within or near the HVAC system of a building, the aerosolizer is filled with a bioagent broth or other liquid containing the CBRN agent, and the aerosolizer is either manually activated or programmed to release the agent into the air or into a ventilation system at a predetermined time.

U.S. Pat. No. 5,027,643 describes various detectors for detecting the presence of harmful vapors wherein air samples are collected into a trap before being desorbed into a detector, such as an electron capture detector. Unfortunately, these detectors are selective in that they only detect certain elements; thus, if the terrorist uses an element that is not detectable by the detector, such detectors are unable to identify the occurrence of an attack. In addition, many such detectors utilize consumables when they are performing their detection function; thus, it can be costly to use them in a continuous monitoring mode and it would be more cost effective to use them on a selective basis.

Accordingly, it is desirable to have developed a method and system for detection of the aerosol dissemination of contaminants that does not rely upon the chemical or biological characteristics of the contaminant for detection.

### SUMMARY OF THE INVENTION

The present invention is a method for detecting unwanted dissemination of aerosolized agents into an HVAC system in a building by detecting the sound of the dissemination at the time it occurs. To be able to distinguish the sound of the dissemination event from the ambient background noise of the HVAC system, in accordance with the present invention, sound extraction techniques, e.g., high pass filtering and an adaptive variance estimator, are utilized which can detect the event's noise from within the ambient background noise of the system. A microphone or other acoustic sensing device continually monitors background sound levels and senses the additional sound resulting from the activation of the aerosol delivery system, which has a unique sound “signature.” Once an event is detected, defensive actions, e.g., activating additional sensors, closing all air vents, and shutting off the HVAC system, can be taken.

### BRIEF DESCRIPTION OF THE DRAWINGS

FIG. 1 illustrates a typical environment in which a CBRN attack could take place and in which the present invention could be utilized to prevent the CBRN attack; and

FIG. 2 is a flowchart illustrating the processing carried out by processing device 124 of FIG. 1.

### DESCRIPTION OF THE PREFERRED EMBODIMENT(S)

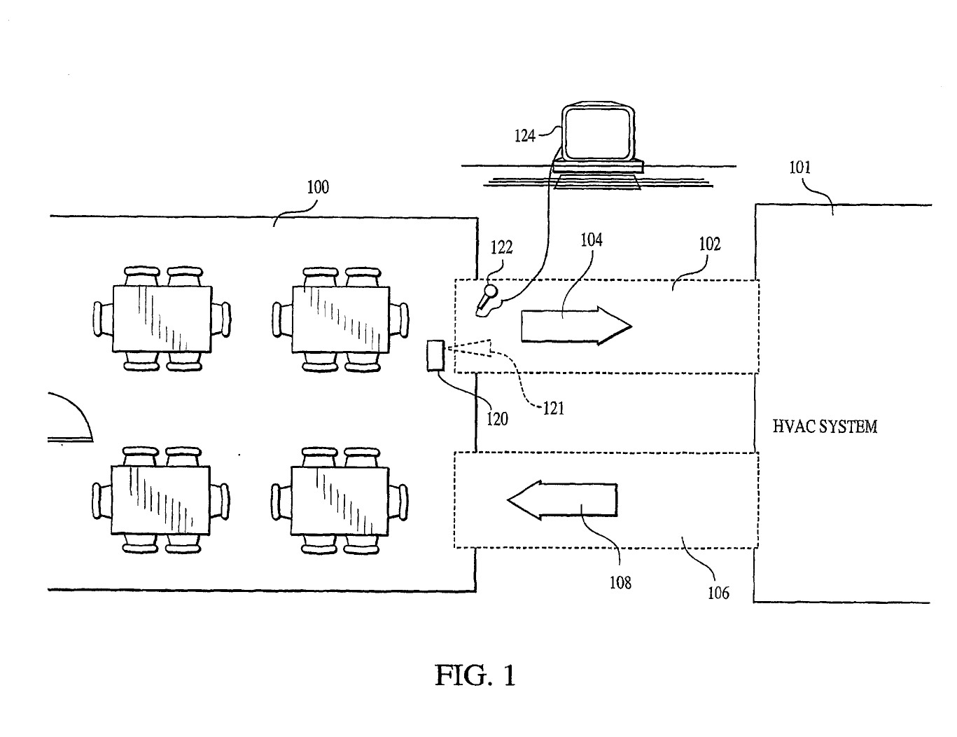

FIG. 1 illustrates a typical environment in which a CBRN attack could take place and in which the present invention could be utilized to prevent the CBRN attack. Referring to FIG. 1, a room to which public access is readily available, e.g., a cafeteria 100, has an HVAC system 101 providing ductwork 102 and 106. Specifically, as shown in FIG. 1, ductwork 102 is a return air vent which draws air in from the cafeteria 100 back into the HVAC system 101. Ductwork 106 comprises a standard feeder duct which provides air to the cafeteria 100. In a well known manner, air is circulated throughout the cafeteria 100 by removing air in direction 104, processing the air through the HVAC system 101, and returning the air so processed back to the cafeteria 100 via ductwork 106 in direction 108.

A typical CBRN attack could occur as follows. An aerosolizer 120 is placed in the vicinity of return 102. In a manually operated fashion, the user would simply spray the aerosolizer 120 into the return 102, and the HVAC system 101 would draw the spray 121, containing the CBRN agent, into the HVAC system. The HVAC system 101 would then process the air (e.g., by cooling or heating the air) and then propel the processed air, carrying the CBRN agent, into the ventilation system for the entire building (including air duct 106). Alternatively, the aerosolizer could be placed somewhere inside the ductwork and be activated remotely or based on a timer system so that the CBRN attack would occur when the perpetrator was not in the vicinity. In any case, the aerosolizer, when activated, will release the CBRN agent via a spraying mechanism that will generate a distinctive sound which is different from the overall sound of the HVAC system 101 in operation and the ambient sound in the cafeteria 100.

In accordance with the present invention, an acoustic detector such as a microphone 122, coupled to a processing device, e.g., a computer 124 equipped with a digital signal processor (DSP) and configured for amplifying, recording, storing, and processing sound signals, is situated within the duct 102. The microphone/processing device combination is configured in a known manner so as to record sounds on a continuous basis and store the recordings in any known manner, e.g., magnetic tape, sound card, etc. The processing device is also configured so as to enable detection of signals that are not generally occurring in the ambient environment, and more specifically, to be able to discriminate between background noise and the sound made by activation of the aerosolizer. Many known techniques for detecting specific sounds from within background sounds are well known; see, for example, U.S. Pat. No. 3,569,923 to Naubereit et al., incorporated herein fully by reference.

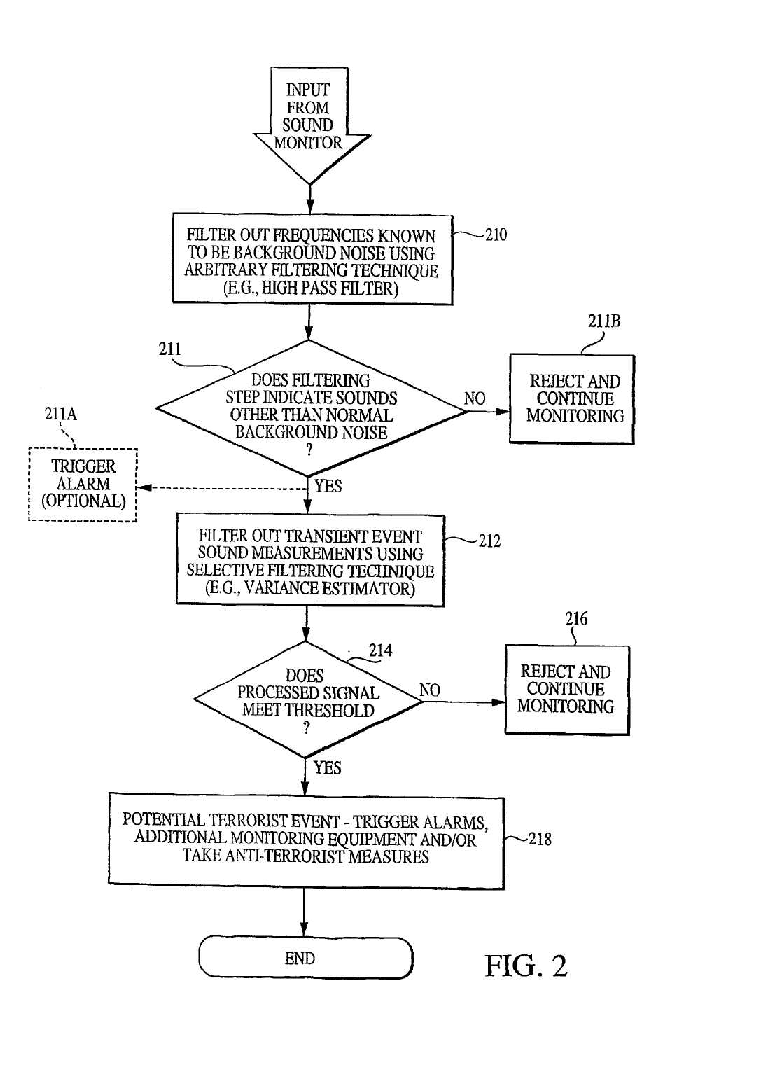

FIG. 2 is a flowchart illustrating the processing carried out by processing device 124 of FIG. 1. Referring to FIG. 2, at step 210, after having received sound signals from microphone 122, background noise is filtered out using known arbitrary filtering techniques, e.g., through the use of a high pass filter that will only pass sound signals for sounds which exceed 5 kHz. As is well known, to be able to accurately distinguish background noise from the sound of an unidentified “event” such as a CBRN attack, it may be necessary to first take a reference sound reading at a time when it is known that no CBRN attack is occurring, thereby enabling the abnormal event to be detected.

Depending upon the sensitivity and accuracy required, the threshold level of the high pass filter can be varied. For example, during operation a typical aerosolizer emits a sound bandwidth of approximately 1 to 20 kHz or higher; sounds typical of a “normal living environment” (e.g., an office building or residence) are usually in a bandwidth of approximately 20 Hz-10 kHz and rarely exceed a frequency of 8 kHz. Thus, if it is desired to have a more sensitive, but less accurate detection system, the high pass filtering performed by processing device 124 can be set to a lower level, e.g., 5 kHz. This will pass some of the background noise of the normal living environment, and will pass more of the frequencies generated by the areosolizer. On the other hand, if a less sensitive, but more accurate detection system is desired, the high pass filtering process carried out by processing device 124 can be set closer to the typical sound frequency of an aerosolizer (and farther away from the typical sound frequency of a normal living environment), e.g., above 10 kHz, 15 kHz, 18 kHz, 20 kHz, etc. The threshold level can be selected to be any level at or above the lowest level that would enable the sound of the aerosolizer to be distinguished from the background level.

Utilizing only high pass filtering, adequate results can be achieved. If the frequency of sounds in the area surrounding the microphone exceeds the filter threshold, the detector will detect these occurrences and treat these occurrences as aberrations indicative of a potential attack. Thus, at step 211, if a determination is made that sounds other than the expected background noise are occurring and, more particularly, that those sounds are consistent in character with the sound made by a discharging aerosolizer (e.g., they are sounds at a frequency of 10 kHz or higher), optionally an alarm can be triggered (step 211A). If no such determination is made, the process can proceed to step 211B, where the monitoring continues. However, to improve the operation of the system further, the processing device 124 can be configured to refrain from issuing an indication of a potential alarm event until the detected aberration can be confirmed as being more than merely a transient occurrence, as described below.

For example, in any environment there may be isolated occurrences of high frequency sounds of short duration. An aerosol sprayer being activated for purposes of a terrorist attack would emit this high frequency sound for a sustained period of time, e.g., at least 10 seconds and more likely 30 seconds or more. Accordingly, at step 212, processing device 124 filters out transient event sound measurements using any known selective filtering technique that will achieve this goal, e.g., by the use of a variance estimator. As is well known in the art variance estimators give less weight to recently occurring detections and more weight to “older” detections, so that only after the occurrence of a noise event above the threshold of the high pass filter and which occurs for a predetermined period of time, e.g., ten seconds or more (more or less, depending upon the desired accuracy), will there be an indication of a confirmation of an alarm event.

At step 214, a determination is made as to whether or not signals being output from the selective filtering process have met the required thresholds. If not, at step 216, the signal is rejected as being a transient event and monitoring of the sound continues. However, if a sound event does meet the predetermined thresholds, at step 218 a determination is made that it is a potential terrorist event, whereby alarms may be triggered, additional monitoring equipment may be activated, and anti-terrorist measures can be taken.

All of the sound processing described above can be accomplished using known techniques using hardware, software, or a combination of both. There are many examples of such known techniques, as illustrated in U.S. Pat. Nos. 4,922,467 to Caulfield; 3,681,745 to Perlman et al.; 3,569,923 to Naubereit et al.; and 4,609,994 to Bassim et al..

By implementing the present invention, buildings, vehicles, and the like can be monitored, via sound monitoring, for the occurrence of an event bearing the signature of the spraying of an aerosolizer in an environment where such sounds would not otherwise occur. Once such a sound has been detected and confirmed as not simply a transient event, CBRN detection devices which detect the presence of harmful vapors and/or materials can be immediately activated, thereby minimizing or eliminating the need to run such devices on a continual basis. Further, alarms may be activated to enable the HVAC system to be shut down and to allow building personnel to be evacuated before the harmful effects can be distributed throughout the building.

It should be understood that while the above description illustrates an example in which the sound of the aerosolizer is detected within a building, this example is not intended to be so limiting and it is understood that the present invention will function effectively in any environment where it is desired to detect the release of materials utilizing an aerosolizer or other device exhibiting unique sound characteristics that can be distinguished from background noise as described above.

The foregoing is considered as illustrative only of the principles of the invention. Further, since numerous modifications and changes will readily occur to those skilled in the art it is not desired to limit the invention to the exact construction and applications shown and described. Accordingly, all suitable modifications and equivalents may be resorted to, falling within the scope of the invention and the appended claims and their equivalents.

1. An apparatus for detecting the activation of an aerosol device in a living environment, comprising:
an acoustic sensor outputting electrical signals corresponding to sounds occurring in the vicinity of said acoustic sensor; and
a processor connected to said acoustic sensor and receiving said electrical signals output by said acoustic sensor, said processor outputting a detection signal if said electrical signals indicate the occurrence of the activation of an aerosol device within the living environment.

2. An apparatus as set forth in claim 1, wherein said processor comprises:
a first filter operatively connected to said acoustic sensor, said first filter passing said electrical signals only if said electrical signals possess characteristics indicating the occurrence of a sound that exceeds a predetermined frequency level; and
a first detector operatively connected to said first sensor, said first detector providing a first output signal upon receipt of electrical signals passed by said first filter.

3. An apparatus as set forth in claim 2, wherein said processor further comprises:
a second filter operatively connected to said first filter, said second filter passing said electrical signals output by said first filter only if said electrical signals have a continuous duration exceeding a predetermined time; and
a second detector operatively connected to said second filter, said second detector providing a second output signal upon receipt of electrical signals passed by said second filter.

4. An apparatus as set forth in claim 3, wherein said first filter is a high pass filter.

5. An apparatus as set forth in claim 4, wherein said second sensor comprises a variance estimator.

6. An apparatus as set forth in claim 3, wherein said predetermined frequency level is at least 5 kHz.

7. An apparatus as set forth in claim 3, wherein said predetermined frequency level is at least 10 kHz.

8. An apparatus as set forth in claim 3, wherein said predetermined frequency level is at least 15 kHz.

9. An apparatus as set forth in claim 3, wherein said predetermined frequency level is at least 18 kHz.

10. An apparatus as set forth in claim 3, wherein said predetermined frequency level is at least 20 kHz.

11. An apparatus as set forth in claim 3, wherein said predetermined time is at least 10 seconds.

12. An apparatus as set forth in claim 3, wherein said predetermined time is at least 20 seconds.

13. An apparatus as set forth in claim 3, wherein said predetermined time is at least 30 seconds.

14. An apparatus as set forth in claim 3, wherein said predetermined time is at least 40 seconds.

15. An apparatus as set forth in claim 3, wherein said predetermined time is at least 50 seconds.

16. An apparatus as set forth in claim 3, wherein said predetermined time is at least 60 seconds.

17. An apparatus for detecting the activation of a terrorist device exhibiting an identifiable sound characteristic when activated, comprising:
an acoustic sensor outputting electrical signals corresponding to sounds occurring in the vicinity of said acoustic sensor; and
a processor connected to said acoustic sensor and receiving said electrical signals output by said acoustic sensor, said processor outputting a detection signal if said electrical signals indicate the occurrence of the activation of said terrorist device within the living environment.

18. An apparatus as set forth in claim 17, wherein said processor comprises:
a first filter operatively connected to said acoustic sensor, said first filter passing said electrical signals only if said electrical signals possess characteristics indicating the occurrence of a sound that exceeds a predetermined frequency level; and
a first detector operatively connected to said first sensor, said first detector providing a first output signal upon receipt of electrical signals passed by said first filter.

19. An apparatus as set forth in claim 18, wherein said processor further comprises:
a second filter operatively connected to said first filter, said second filter passing said electrical signals output by said first filter only if said electrical signals have a continuous duration exceeding a predetermined time; and
a second detector operatively connected to said second filter, said second detector providing a second output signal upon receipt of electrical signals passed by said second filter.

20. A method of detecting the activation of an aerosol device in a living environment, comprising the steps of:
continuously monitoring all sounds occurring within the living environment;
processing said monitored sounds to detect the occurrence of sounds consistent with the activation of an aerosol device; and
outputting an alarm signal if a sound consistent with the activation of an aerosol device is detected.

21. The method of claim 19, further comprising the steps of:
measuring the duration of detected sounds consistent with the activation of an aerosol device; and
only outputting said alarm signal if said measured duration exceeds a predetermined duration.

22. A method of detecting the activation of an aerosol device in a living environment, comprising the steps of:
continuously monitoring all sounds occurring within the living environment;
processing said monitored sounds to detect the occurrence of sounds consistent with the activation of an aerosol device;
outputting an alarm signal if a sound consistent with the activation of an aerosol device is detected;
measuring the duration of detected sounds consistent with the activation of an aerosol device; and
only outputting said alarm signal if said measured duration exceeds a predetermined duration.
